(19) United States
(12) Patent Application Publication
(10) Pub. No.: US 2011/0266106 A1
(43) Pub. Date: Nov. 3, 2011

(54) BRAKE CONTROL APPARATUS AND BRAKE CONTROL METHOD

(75) Inventor: Masakuni Suzuki, Aichi-ken (JP)

(73) Assignee: TOYOTA JIDOSHA KABUSHIKI KAISHA, Aichi-ken (JP)

(21) Appl. No.: 13/142,399

(22) PCT Filed: Dec. 21, 2009
(86) PCT No.: PCT/IB2009/007837

§ 371 Date: Jun. 27, 2011

(30) Foreign Application Priority Data
Dec. 26, 2008 (JP) 2008-332681

(51) Int. Cl. B60T 13/68

(52) U.S. Cl. 188/360; 188/152

(57) ABSTRACT

A brake control apparatus includes an electric power supply, a fluid pressure source whose operating fluid pressure fluctuates by a driver's operation, a wheel cylinder for applying a braking force to a wheel using an operating fluid supplied from the fluid pressure source, a control valve provided between the fluid pressure source and the wheel cylinder and mechanically opened by a differential pressure when a higher pressure is applied to the fluid pressure source than to the wheel cylinder, and a control portion for opening/closing the control valve through a control current. The control valve is a normally open valve that is closed through a prescribed control current set not to mechanically open the control valve by the differential pressure during normal braking. The control portion closes the control valve through a control current smaller than the prescribed control current when the electric power supply is in a low-voltage state.

### BACKGROUND OF THE INVENTION

1. Field of the Invention

The invention relates to a brake control apparatus and a brake control method that are intended to control a braking force of a vehicle.

2. Description of the Related Art

For example, it is described in Japanese Patent Application Publication No. 2005-297777 (JP-A-2005-297777) that a master shutoff valve is opened to establish a manual mode in a fluid pressure brake when there is a braking request from a driver and a starter switch is on or a fall in the voltage of a battery is detected. A deficiency in braking force in the manual mode is compensated for by an electric parking brake.

However, it is preferable from the standpoint of failsafe that a fluid pressure brake device be also endowed with the function of compensating for a braking force. Further, it is also preferable to achieve both the securement of a braking force and the efficient management of an electric power supply at low voltage.

### SUMMARY OF THE INVENTION

Thus, the invention provides a brake control apparatus and a brake control method that easily secure a required braking force even when an electric power supply voltage falls.

A brake control apparatus according to a first aspect of the invention is equipped with an electric power supply, a fluid pressure source whose operating fluid pressure fluctuates in response to an operation of a driver, a wheel cylinder that is supplied with an operating fluid from the fluid pressure source to apply a braking force to a wheel, a control valve that is provided between the fluid pressure source and the wheel cylinder and can be mechanically opened through an effect of a differential pressure at a time when a higher pressure is applied to the fluid pressure source side than to the wheel cylinder side, and a control portion that controls opening/closing of the control valve through a control current. The control valve is a normally open valve that is closed through a prescribed control current that is so set as not to mechanically open the control valve through the effect of the differential pressure during normal braking. The control portion determines whether or not the electric power supply is in a low-voltage state, and closes the control valve through a control current smaller than the prescribed control current upon determining that the electric power supply is in the low-voltage state.

According to this first aspect of the invention, electric power can be saved through a reduction in a valve-closing current to the normally open control valve in the low-voltage state. Further, the valve-opening pressure of the control valve is reduced by reducing the valve-closing current. Therefore, the control valve can be mechanically opened through a fluid pressure when the driver requires a large braking force. Thus, both the reduction of electric power consumption in the low-voltage state and the securement of a braking force can be realized.

Further, the brake control apparatus may further be equipped with wheel cylinder pressure control means capable of controlling a wheel cylinder pressure independently of a brake operation of the driver. The control portion may set an upper limit for the wheel cylinder pressure rendered by the wheel cylinder pressure control means in the low-voltage state, and control a control current in the low-voltage state such that the control valve is mechanically opened when a required wheel cylinder pressure is higher than the upper limit.

In this manner, high-pressure fluid pressure control in the low-voltage state can be avoided by setting an upper-limit pressure for the wheel cylinder pressure control means. As a result, the amount of electric power consumption can further be reduced.

Further, the brake control apparatus may further be equipped with a motive power source for pressurizing and storing an operating fluid. The control portion may operate the motive power source at a lower speed than usual in the low-voltage state.

In this manner, the amount of electric power consumption can further be reduced by operating the motive power source for pressurizing the operating fluid at low speed.

A second aspect of the invention relates to a control method for a brake. The brake includes an electric power supply, a fluid pressure source whose operating fluid pressure fluctuates in response to an operation of a driver, a wheel cylinder that is supplied with an operating fluid from the fluid pressure source to apply a braking force to a wheel, and a control valve that is provided between the fluid pressure source and the wheel cylinder and can be mechanically opened through an effect of a differential pressure at a time when a higher pressure is applied to the fluid pressure source side than to the wheel cylinder side. The control valve is a normally open valve that is closed through a prescribed control current that is so set as not to mechanically open the control valve through the effect of the differential pressure during normal braking. The control method includes determining whether or not the electric power supply is in a low-voltage state, and closing the control valve through a control current smaller than the prescribed control current when it is determined that the electric power supply is in the low-voltage state.

According to this second aspect of the invention, electric power can be saved through a reduction in the valve-closing current to the normally open control valve in the low-voltage state. Further, the valve-opening pressure of the control valve is reduced by reducing the valve-closing current. Therefore, the control valve can be mechanically opened through a fluid pressure when the driver requires a large braking force. Thus, both the reduction of electric power consumption in the low-voltage state and the securement of a braking force can be realized.

According to the invention, there is provided a brake control apparatus that easily secures a required braking force even when an electric power supply voltage falls.

### BRIEF DESCRIPTION OF THE DRAWINGS

The foregoing and further features and advantages of the invention will become apparent from the following description of an example embodiment with reference to the accompanying drawings, wherein like numerals are used to represent like elements, and wherein:

FIG. 1 is a schematic diagram showing a brake control apparatus according to one embodiment of the invention;

FIG. 2 is an example of a control block diagram regarding brake control according to the embodiment of the invention;

FIG. 3 is a flowchart for explaining an example of a brake control processing according to the embodiment of the invention; and

FIG. 4 is a flowchart for explaining an example of a low-voltage mode according to the embodiment of the invention.

### DETAILED DESCRIPTION OF THE EMBODIMENT

According to one embodiment of the invention, a brake control apparatus makes a changeover between a normal brake control mode (so-called brake-by-wire) and a backup brake mode as needed to appropriately control a braking force. The brake control apparatus may further be designed to select a low-voltage mode to control the braking force. In the low-voltage mode, an electric power saving level may be selected in accordance with a state of an electric power supply. For example, the low-voltage mode may be so set as to raise the electric power saving level as the voltage of the electric power supply falls. Both the management of the electric power supply for reducing electric power consumption and the securement of a braking force can be achieved by appropriately setting the low-voltage mode.

The low-voltage mode is, as it were, an intermediate brake mode between a normal mode and a backup mode. The low-voltage mode may be selected when, for example, the voltage of an electric power supply for a brake actuator for controlling a brake fluid pressure falls although no abnormality is detected in the brake actuator. Alternatively, the low-voltage mode may be selected upon a collision of a vehicle. The low-voltage mode may be selected in operating the brake control apparatus with an auxiliary electric power supply as a measure against the occurrence of an abnormality in a main electric power supply for the vehicle.

In typical brake control according to the related art, when some abnormality is detected, a changeover to a non-controlled state is made immediately. Therefore, the braking force is smaller than in a controlled state. However, in the embodiment of the invention, the braking force can be held completely through the introduction of the low-voltage mode. Even if the braking force decreases, the decrease in the braking force can be minimized.

According to the embodiment of the invention, the brake control apparatus may be equipped with a control portion that closes a control valve during normal operation in response to a braking operation of a driver and performs control of the control valve during abnormal operation such that the control valve is mechanically opened through an effect of a lower differential pressure than during normal operation. That is, the control portion performs control so as to reduce the valve-opening pressure of the control valve during abnormal operation. The control valve may be a control valve that is provided between a fluid pressure source and a wheel cylinder and can be mechanically opened through an effect of a differential pressure at a time when a higher pressure is applied to the fluid pressure source side than to the wheel cylinder side. The fluid pressure may be a manual fluid pressure source whose operating fluid pressure fluctuates in response to an operation of the driver. The control valve may be, for example, a master cut valve, and the fluid pressure source may be, for example, a master cylinder. The brake control apparatus may further be equipped with wheel cylinder pressure control means capable of controlling, through the supply of motive power, a wheel cylinder pressure independently of a brake operation of the driver at least during normal operation.

In this manner, when the driver requires a large braking force during abnormal operation, the closed control valve can be mechanically opened through the effect of a fluid pressure. As a result, the fluid pressure can be supplementarily introduced into the wheel cylinder from the fluid pressure source, which is interlocked with the operation of the driver. Therefore, a large braking force is secured with ease even during abnormal operation.

According to the embodiment of the invention, the control valve may be a normally open valve that is closed through a prescribed control current during normal braking. The prescribed control current may be set such that the control valve is not mechanically opened through the effect of a differential pressure during normal braking. That is, a valve-closing current may be so set as to hold the control valve closed even at a maximum differential pressure applicable during normal operation. The control portion may control the opening/closing of the control valve through a control current. The control portion may determine whether or not the electric power supply is in the low-voltage state. When it is determined that the electric power supply is not in the low-voltage state but in a normal state, the control portion may supply the control valve with the prescribed control current as the valve-closing current. When it is determined that the electric power supply is in the low-voltage state, the control portion may supply the control valve with a control current smaller than the prescribed control current as the valve-closing current. The valve-closing current in the low-voltage state may be set such that the valve-opening pressure of the control valve becomes lower than the maximum differential pressure applicable to the control valve during normal operation. Thus, both the reduction of electric power consumption in the low-voltage state and the securement of a braking force can be realized.

The control portion may set an upper limit for the wheel cylinder pressure rendered by the wheel cylinder pressure control means in the low-voltage state. In this case, the wheel cylinder pressure control means may be designed to control the wheel cylinder pressure upon being supplied with electric power from the electric power supply. The control portion may control a low-voltage control current such that the control valve is mechanically opened when the required wheel cylinder pressure becomes higher than the upper limit. Therefore, the wheel cylinder pressure is supplemented through the mechanical opening of the control valve when the required braking force is large. This upper limit may be set such that a certain ratio of a required braking force range possible during normal operation (e.g., a predetermined ratio, for example, 90% or less of a maximum value assumable as the required braking force) is covered only by the wheel cylinder pressure control means. That is, the wheel cylinder pressure control means may control the fluid pressure within a normal braking force range, and the manual fluid pressure source may be used in combination with the wheel cylinder pressure control means when a braking force exceeding the normal braking force range is required (e.g., at the time of sudden braking). Thus, a good brake feeling can be offered as long as the required braking force is confined within the normal range.

The wheel cylinder pressure control means may be equipped with an accumulator for storing an operating fluid. The brake control apparatus is provided with the accumulator as a fluid pressure source other than the manual fluid pressure source. Further, the wheel cylinder pressure control means may be equipped with a motive power source for supplying the accumulator with the high-pressure operating fluid. The motive power source may be equipped with, for example, a pump for boosting the pressure of the operating fluid, and a motor for driving the pump. The motive power source may be designed to boost the pressure of the operating fluid upon being supplied with electric power from the electric power supply.

The control portion may operate the motive power source at a lower speed than usual in the low-voltage state. For example, the control portion may operate the motor at a lower rotational speed than usual. Further, the control portion may limit the pressure of the accumulator to a lower pressure than usual in the low-voltage state. Thus, the amount of electric power consumption can further be reduced.

Further, the brake control apparatus may be equipped with a main electric power supply and an auxiliary electric power supply. The main electric power supply may be, for example, a battery mounted on the vehicle, and the auxiliary electric power supply may be, for example, a storage device or capacitor that is provided as an attachment to the brake control apparatus. The brake control apparatus may be designed to be supplied with electric power from the main electric power supply during normal operation and be supplied with electric power from the auxiliary electric power supply in the low-voltage state. When being supplied with electric power from the auxiliary electric power supply, the brake control apparatus may stop fluid pressure control of one or some of wheel cylinders, and continue fluid pressure control of the other wheel cylinders or the other wheel cylinder.

The control portion may determine whether or not the vehicle has undergone a collision, and operate the motive power source to pressurize the operating fluid upon determining that the vehicle has undergone a collision. More specifically, the control portion may drive the motor to operate the pump and enhance the pressure of the accumulator upon determining that the vehicle has undergone a collision. Thus, a braking force in the event of the collision can be secured, or preparations for the braking after the collision can be made.

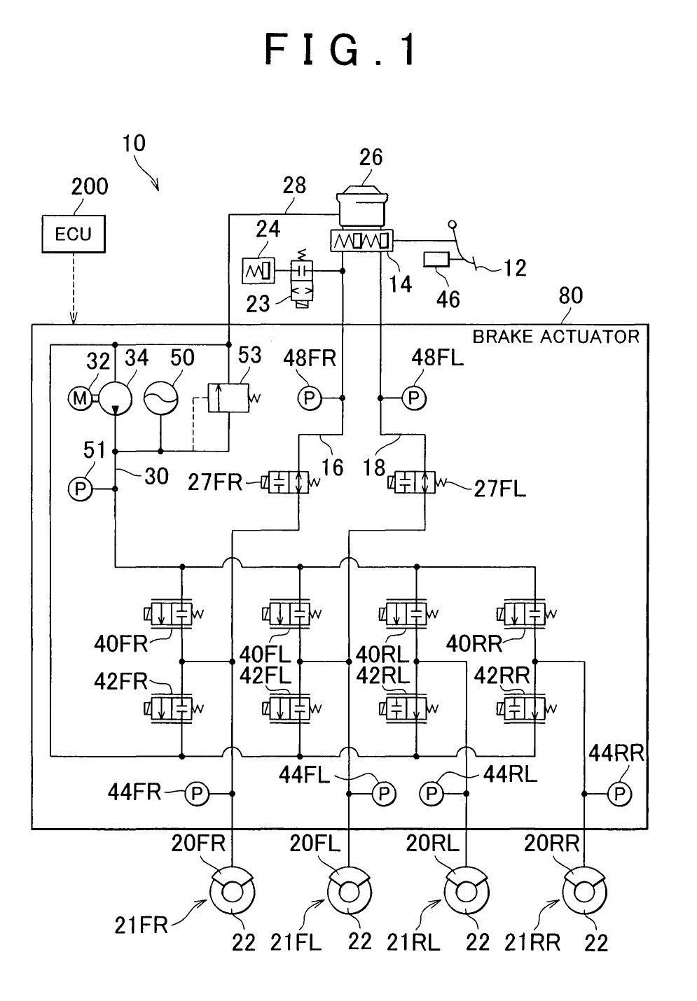

FIG. 1 is a schematic diagram showing a brake control apparatus 10 according to the embodiment of the invention. The brake control apparatus 10 shown in FIG. 1 constitutes an electronically controlled brake system for a vehicle, and sets brakes for four wheels of the vehicle independently and optimally in accordance with an operation of a brake pedal 12 as a brake operation member by a driver. Further, the vehicle mounted with the brake control apparatus 10 according to this embodiment of the invention is equipped with a steering device (not shown) that steers those of the four wheels which serve as steering wheels, a running drive source (not shown) that drives those of the four wheels which serve as driving wheels, such as an internal combustion engine, a motor, or the like, and the like.

The brake control apparatus 10 according to this embodiment of the invention is mounted on, for example, a hybrid vehicle that is equipped with an electric motor and an internal combustion engine as running drive sources. In this hybrid vehicle, the vehicle can be braked through the use of regenerative braking and fluid pressure braking. In regenerative braking, the vehicle is braked by regenerating kinetic energy of the vehicle into electric energy. In fluid pressure braking, the vehicle is braked by the brake control apparatus 10. The vehicle in this embodiment of the invention can perform brake regeneration cooperative control to generate a desired braking force through the combination of regenerative braking and fluid pressure braking.

Disc brake units 21FR, 21FL, 21RR, and 21RL as braking force application mechanisms apply braking forces to a front-right wheel of the vehicle, a front-left wheel of the vehicle, a rear-right wheel of the vehicle, and a rear-left wheel of the vehicle respectively. The disc brake units 21FR to 21RL include brake discs 22 and wheel cylinders 20FR to 20RL built in brake calipers respectively. The wheel cylinders 20FR to 20RL are connected to a brake actuator 80 via different fluid passages respectively. In the following description, the wheel cylinders 20FR to 20RL will be comprehensively referred to as “the wheel cylinders 20” when appropriate.

In the brake control apparatus 10, the brake actuator 80 is configured to include a right master cut valve 27FR, a left master cut valve 27FL, pressure increasing valves 40FR to 40RL, pressure reducing valves 42FR to 42RL, an oil pump 34, an accumulator 50, and the like, which will be described later. When the wheel cylinders 20 are supplied with brake fluid from the brake actuator 80, brake pads as frictional members are respectively pressed against the brake discs 22, which rotate together with the wheels respectively. Thus, braking forces are applied to the wheels respectively.

Although the disc brake units 21FR to 21RL are employed in this embodiment of the invention, other braking force application mechanisms including the wheel cylinders 20, such as drum brakes or the like, may be employed instead. Alternatively, braking force application mechanisms that control the pressing forces exerted on the wheels by frictional members through the use of electric drive mechanisms such as electric motors or the like instead of controlling the pressing forces of the frictional members through fluid forces can also be employed.

The brake pedal 12 is connected to a master cylinder 14 that delivers brake fluid as the operating fluid in response to a depression operation of the driver. The brake pedal 12 is provided with a stroke sensor 46 for detecting a depression stroke of the driver. The stroke sensor 46 may be constituted by sensors belonging to two different systems respectively and arranged in parallel with each other. A stroke simulator 24 that creates a reactive force corresponding to an operational force of the brake pedal 12 exerted by the driver is connected to one of output ports of the master cylinder 14. A simulator cut valve 23 is provided such that a flow passage that connects the master cylinder 14 to the stroke simulator 24 extends therethrough. The simulator cut valve 23 is a normally closed electromagnetic open/close valve that is closed during stoppage of energization and is shifted to an open state upon detection of an operation of the brake pedal 12 by the driver. It should be noted that the installation of the simulator cut valve 23 is not indispensable, and that the stroke simulator 24 may be directly connected to the master cylinder 14 without the intermediary of the simulator cut valve 23.

In addition, a brake hydraulic control pipe 16 for the front-right wheel is connected to one of the output ports of the master cylinder 14. The brake hydraulic control pipe 16 is connected to the wheel cylinder 20FR for the front-right wheel, which applies a braking force to the front-right wheel (not shown). Further, a brake hydraulic control pipe 18 for the front-left wheel is connected to the other output port of the master cylinder 14. The brake hydraulic control pipe 18 is connected to the wheel cylinder 20FL for the front-left wheel, which applies a braking force to the front-left wheel (not shown).

The right master cut valve 27FR is provided such that the brake hydraulic control pipe 16 for the front-right wheel extends therethrough, and the left master cut valve 27FL is provided such that the brake hydraulic control pipe 18 for the front-left wheel extends therethrough. In the following description, the right master cut valve 27FR and the left master cut valve 27FL will be comprehensively referred to as the master cut valves 27 when appropriate.

Each of the master cut valves 27 is a normally open electromagnetically controlled valve that has an on-off controlled solenoid and a spring, is guaranteed to be closed through an electromagnetic force generated by the solenoid upon being supplied with a prescribed control current, and is open during stoppage of energization of the solenoid. The open master cut valves 27 can cause brake fluid to flow in both directions between the master cylinder 14 and the wheel cylinders 20FR and 20FL on the front wheel side respectively. When each of the master cut valves 27 is closed through the supply of the prescribed control current to the solenoid, the flow of brake fluid is shut off.

When a master cylinder pressure is higher than a wheel cylinder pressure, a differential pressure therebetween acts in such a direction as to open a corresponding one of the master cut valves 27. That is, each of the master cut valves 27 is disposed such that a so-called self-opening direction thereof coincides with a direction from the master cylinder 14 to a corresponding one of the wheel cylinders 20. Therefore, when a higher pressure is applied to the master cylinder 14 than to a certain one of the wheel cylinders 20 and the differential pressure therebetween is higher than a valve-opening pressure of a corresponding one of the master cut valves 27, this master cut valve 27 is mechanically opened due to the effect of the differential pressure.

The magnitude of this valve-opening pressure is determined in accordance with the magnitude of the control current to the master cut valve 27. The valve-opening pressure is increased as the control current is increased. Accordingly, it becomes easier to hold the master cut valve 27 closed against the differential pressure as the control current is increased. That is, the valve-opening pressure is a fluid pressure at which a valve closed through the supply of a valve-closing current is opened due to the effect of a differential pressure applied thereto when the differential pressure is gradually increased. Therefore, the value of the valve-closing current has a predetermined relationship (e.g., a linear relationship) with the valve-opening pressure. In general, the value of the aforementioned prescribed control current is set such that the valve-opening pressure becomes higher than a maximum differential pressure applicable to the master cut valve 27. This aims at guaranteeing that the master cut valve 27 is held closed in accordance with a valve-closing command from the control portion instead of being mechanically opened during the closing thereof.

Further, a right master pressure sensor 48FR for detecting a master cylinder pressure on the front-right wheel side is provided such that the brake hydraulic control pipe 16 for the front-right wheel extends therethrough, and a left master pressure sensor 48FL for measuring a master cylinder pressure on the front-left wheel side is provided such that the brake hydraulic control pipe 18 for the front-left wheel extends therethrough. In the brake control apparatus 10, when the driver depresses the brake pedal 12, the stroke sensor 46 detects a depression operation amount of the brake pedal 12. However, a depression operation force (depression force) of the brake pedal 12 can also be calculated from a master cylinder pressure detected by the right master pressure sensor 48FR and the left master pressure sensor 48FL. In this manner, a failsafe configuration may be realized by monitoring the master cylinder pressure by means of the two pressure sensors 48FR and 48FL in prospect of a breakdown of the stroke sensor 46. In the following description, the right master pressure sensor 48FR and the left master pressure sensor 48FL will be comprehensively referred to as the master pressure sensors 48 when appropriate.

Further, a reservoir tank 26 for storing brake fluid is connected to the master cylinder 14. A hydraulic supply/exhaust pipe 28 is connected at one end thereof to the reservoir tank 26. A suction port of the oil pump 34, which is driven by the motor 32, is connected to the other end of the hydraulic supply/exhaust pipe 28. A discharge port of the oil pump 34 is connected to a high-pressure pipe 30. The accumulator 50 and a relief valve 53 are connected to this high-pressure pipe 30. In this embodiment of the invention, a reciprocating pump equipped with two or more pistons (not shown) that are reciprocally moved by the motor 32 is adopted as the oil pump 34. Further, an accumulator that converts pressure energy of brake fluid into pressure energy of a filler gas such as nitrogen or the like and accumulates this pressure energy is adopted as the accumulator 50. It should be noted that the motor 32, the oil pump 34, and the accumulator 50 may be configured as a power supply unit separate from the brake actuator 80 and provided outside the brake actuator 80.

The accumulator 50 accumulates brake fluid whose pressure has been boosted to, for example, about 14 to 22 MPa by the oil pump 34. Further, a valve outlet of the relief valve 53 is connected to the hydraulic supply/exhaust pipe 28. When the pressure of brake fluid in the accumulator 50 abnormally rises to, for example, about 25 MPa, the relief valve 53 opens, and high-pressure brake fluid is returned to the hydraulic supply/exhaust pipe 28. In addition, the high-pressure pipe 30 is provided with an accumulator pressure sensor 51 that detects an outlet pressure of the accumulator 50, namely, a pressure of brake fluid in the accumulator 50.

The high-pressure pipe 30 is connected to the wheel cylinder 20FR for the front-right wheel, the wheel cylinder 20FL for the front-left wheel, the wheel cylinder 20RR for the rear-right wheel, and the wheel cylinder 20RL for the rear-left wheel via the pressure increasing valves 40FR, 40FL, 40RR, and 40RL respectively. In the following description, the pressure increasing valves 40FR to 40RL will be comprehensively referred to as “the pressure increasing valves 40” when appropriate. Each of the pressure increasing valves 40 is a normally closed electromagnetic flow rate control valve (linear valve) that has a linear solenoid and a spring and is closed during stoppage of energization of the solenoid. Each of the pressure increasing valves 40 is installed such that a differential pressure between an accumulator pressure on the upstream side and a wheel cylinder pressure on the downstream side acts as a force that opens the valve. The opening degree of each of the pressure increasing valves 40 is adjusted in proportion to the current supplied to the solenoid thereof. Each of the wheel cylinders 20 is supplied with an upstream pressure, namely, an accumulator pressure through a corresponding one of the pressure increasing valves 40 and thus is increased in pressure.

Further, the wheel cylinder 20FR for the front-right wheel and the wheel cylinder 20FL for the front-left wheel are connected to the hydraulic supply/exhaust pipe 28 via the pressure reducing valves 42FR and 42FL on the front wheel side respectively. The pressure reducing valves 42FR and 42FL are normally closed electromagnetic flow rate control valves (linear valves) that are utilized to reduce the pressures in the wheel cylinders 20FR and 20FL respectively as needed. Each of the pressure reducing valves 42FR and 42FL has a linear solenoid and a spring, and is closed during stoppage of energization of the solenoid. The opening degree of each of the pressure reducing valves 42FR and 42FL is adjusted in proportion to the current supplied to the solenoid thereof. Each of the pressure reducing valves 42FR and 42FL is installed such that a differential pressure between a wheel cylinder pressure on the upstream side and a reservoir pressure (atmospheric pressure) on the downstream side acts as a force that opens the valve.

On the other hand, the wheel cylinder 20RR for the rear-right wheel and the wheel cylinder 20RL for the rear-left wheel are connected to the hydraulic supply/exhaust pipe 28 via the pressure reducing valves 42RR and 42RL as normally open electromagnetic flow rate control valves respectively. Each of the pressure reducing valves 42RR and 42RL on the rear wheel side has a linear solenoid and a spring, and is open during stoppage of energization of the solenoid. The opening degree of each of the pressure reducing valves 42RR and 42RL is adjusted in proportion to the current supplied to the solenoid thereof. Further, each of the pressure reducing valves 42RR and 42RL is closed when the magnitude of the current becomes larger than a predetermined current value determined in accordance with a corresponding wheel cylinder pressure. Each of the pressure reducing valves 42RR and 42RL is installed such that a differential pressure between a wheel cylinder pressure on the upstream side and a reservoir pressure (atmospheric pressure) on the downstream side acts as a force that opens the valve. In the following description, the pressure reducing valves 42FR to 42RL will be comprehensively referred to as “the pressure reducing valves 42” when appropriate.

Wheel cylinder pressure sensors 44FR, 44FL, 44RR, and 44RL that detect wheel cylinder pressures as pressures of brake fluid applied to the corresponding wheel cylinders 20 respectively are provided in the vicinity of the wheel cylinder 20FR for the front-right wheel, the wheel cylinder 20FL for the front-left wheel, the wheel cylinder 20RR for the rear-right wheel, and the wheel cylinder 20RL for the rear-left wheel respectively. In the following description, the wheel cylinder pressure sensors 44FR to 44RL will, be comprehensively referred to as “the wheel cylinder pressure sensors 44” when appropriate.

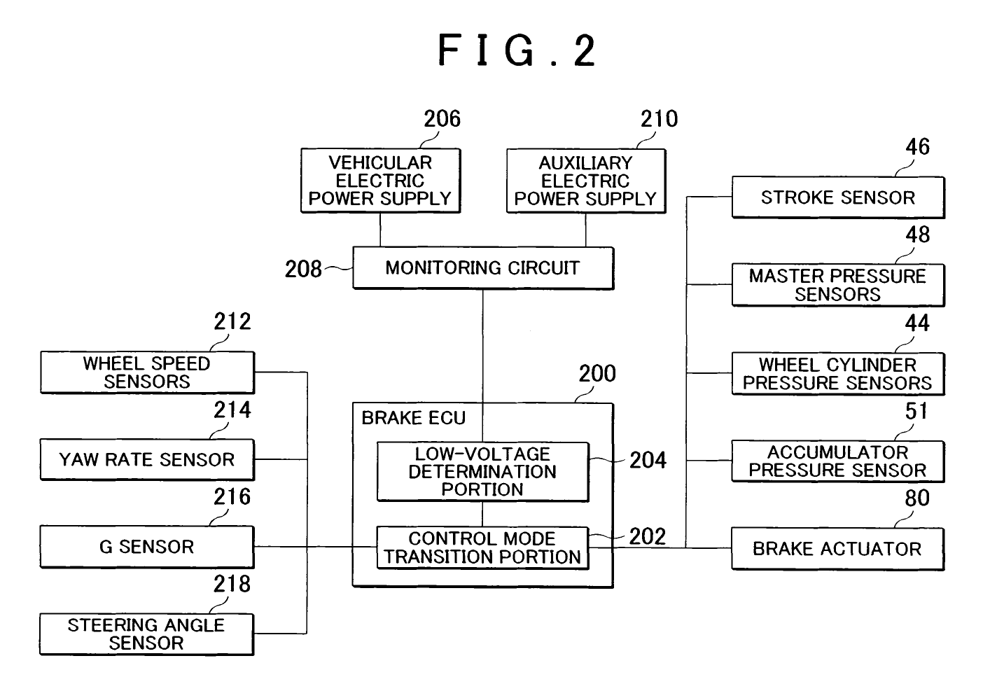

As shown in FIG. 2, the brake actuator 80 is controlled by an electronic control unit (hereinafter referred to as “the ECU”) 200 as a control portion in this embodiment of the invention. The brake ECU 200 is equipped with a CPU for performing various calculation processings, a ROM for storing various control programs, a RAM utilized as a work area for storing data and executing programs, an input/output interface, a memory, and the like.

The brake control apparatus 10 configured as described above can perform brake regeneration cooperative control. The brake control apparatus 10 starts braking the vehicle upon receiving a braking request. The braking request is made when a braking force should be applied to the vehicle, for example, when the driver operates the brake pedal 12. In response to the braking request, the brake ECU 200 calculates a target deceleration, namely, a required braking force from a depression stroke of the brake pedal 12 and a master cylinder pressure. By subtracting a braking force generated through regeneration from the required braking force, the brake ECU 200 calculates a required fluid pressure braking force as a braking force to be generated by the brake control apparatus 10. It should be noted herein that the value of the braking force generated through regeneration is supplied to the brake control apparatus 10 from a high-order hybrid ECU (not shown). The brake ECU 200 then calculates target fluid pressures in the respective wheel cylinders 20FR to 20RL on the basis of the calculated required fluid pressure braking force. The brake ECU 200 determines, through feedback control, the values of control currents supplied to the pressure increasing valves 40 and the pressure reducing values 42 respectively such that the wheel cylinder pressures become equal to the target fluid pressures respectively. The brake ECU 200 repeats the calculation of the target deceleration and the target fluid pressures and the control of the control valves on a predetermined cycle during braking of the vehicle.

As a result, in the brake control apparatus 10, brake fluid is supplied from the accumulator 50 to the wheel cylinders 20 via the pressure increasing valves 40 respectively, and desired braking forces are applied to the wheels respectively. Further, brake fluid is discharged from the wheel cylinders 20 via the pressure reducing valves 42 respectively as needed, and the braking forces applied to the respective wheels are adjusted. In this manner, braking force control of so-called brake-by-wire type is performed. In this embodiment of the invention, a wheel cylinder pressure control portion is configured to include the accumulator 50, the pressure increasing valves 40, and the pressure reducing valves 42.

On the other hand, at this moment, the right master cut valve 27FR and the left master cut valve 27FL are usually closed. During brake regeneration cooperative control, a differential pressure corresponding to the magnitude of a regenerative braking force acts between regions upstream and downstream of each of the master cut valves 27. The brake fluid delivered from the master cylinder 14 through depression of the brake pedal 12 by the driver flows into the stroke simulator 24. A suitable pedal reactive force is thus produced.

Even in the case where the required braking force is covered only by a fluid pressure braking force without recourse to a regenerative braking force, the brake control apparatus 10 according to this embodiment of the invention can control the braking force as a matter of course. A control mode in which the braking force is controlled through the pressure increasing valves 40 and the pressure reducing valves 42 regardless of whether or not brake regeneration cooperative control is performed will be referred to hereinafter as “a linear control mode” when appropriate. Alternatively, this control will be sometimes referred to as brake-by-wire control. When the brake system is normal, the linear control mode is usually selected to control the braking force.

During control in the linear control mode, each of the wheel cylinder pressures may deviate from the target fluid pressure thereof due to, for example, a response delay, overshoot, or the like of the operating fluid pressure. The brake ECU 200 periodically determines, on the basis of, for example, measured values of the wheel cylinder pressure sensors 44, whether or not there are response abnormalities in the wheel cylinder pressures respectively. For example, when the amount of deviance of the measured value of a certain one of the wheel cylinder pressures from the target fluid pressure thereof remains larger than a reference for or longer than a predetermined time, the brake ECU 200 determines that there is an abnormality in the control response of the wheel cylinder pressure. When it is determined that there is an abnormality in the control response of the wheel cylinder pressure, the brake ECU 200 stops the linear control mode and makes a changeover in control mode to a backup brake mode.

In a backup mode, an input to the brake pedal 12 by the driver is converted into a fluid pressure and mechanically transmitted to the wheel cylinders 21, and braking forces are applied to the wheels respectively. The brake ECU 200 stops the pressure increasing valves 40 and the pressure reducing valves 42 from being controlled. Thus, the open/closed states of the pressure increasing valves 40 and the pressure reducing valves 42 are initialized. That is, all the pressure increasing valves 40 are closed, those of the pressure reducing valves 42 which are located on the front side, namely, the pressure reducing valves 42FR and 42FL are closed, and those of the pressure reducing valves 42 which are located on the rear side, namely, the pressure reducing valves 42RR and 42RL are opened. Further, the master cut valves 27 are opened.

In this embodiment of the invention, since the wheels are provided with the pressure increasing valves 40 and the pressure reducing valves 42 respectively, the brake ECU 200 may determine whether or not there are response abnormalities in the wheel cylinder pressures individually as to the respective wheels. The brake ECU 200 transits only that one of the wheel cylinders in which an abnormality is detected to the backup mode, and continues the linear control mode as to those of the wheel cylinders whose fluid pressure responses are normal. Accordingly, when an abnormality is detected in the response of the wheel cylinder pressure in the front-right wheel, the pressure increasing valve 40FR and the pressure reducing valve 42FR are closed, and the right master cut valve 27FR is opened to directly introduce the master cylinder pressure. At this moment, the simulator cut valve 23 may be closed. By the same token, when an abnormality is detected in the response of the wheel cylinder pressure in the front-left wheel, the pressure increasing valve 40FL and the pressure reducing valve 42FL are closed, and the left master cut valve 27FL is opened to directly introduce the master cylinder pressure. When an abnormality is detected in the response of the wheel cylinder pressure in one of the rear wheels, the pressure increasing valve 40RR or 40RL is closed, and the pressure reducing valve 42RR or 42RL is opened. Accordingly, no braking force is applied to the rear wheels in the backup mode.

FIG. 2 is an example of a control block diagram regarding brake control according to this embodiment of the invention. The brake ECU 200 is configured to include a control mode transition portion 202 and a low-voltage determination portion 204. The control mode transition portion 202 determines whether or not the response of a brake fluid pressure is within a normal range, and makes a transition in brake mode from the linear control mode to the backup mode upon determining that the response of the brake fluid pressure is not within the normal range. Further, the control mode transition portion 202 makes a transition to the low-voltage mode when a low-voltage state arises in the event of, for example, a collision. The low-voltage determination portion 204 determines whether or not the electric power supply voltage is lower than a predetermined value, and determines that the low-voltage state has arisen upon determining that the electric power supply voltage is lower than the predetermined value.

As described above, the control mode transition portion 202 is configured to receive inputs of measured values of the wheel cylinder pressure sensors 44 provided in the brake actuator 80, the stroke sensor 46, the master pressure sensor 48, and the accumulator pressure sensor 51. The control mode transition portion 202 determines, on the basis of a difference between a measured value of each of the wheel cylinder pressures and the target fluid pressure thereof, whether or not the response of a corresponding brake fluid pressure is within the normal range.

Further, the control mode transition portion 202 is configured to receive inputs of measured values of the various sensors provided in the vehicle, for example, wheel speed sensors 212, a yaw rate sensor 214, a G sensor 216, and a steering angle sensor 218. A vehicle speed is calculated on the basis of measured values of the wheel speed sensors 212. A vehicle acceleration is calculated from a measured value of the G sensor 216. Further, a vehicle body impact value in the event of a collision is calculated from the measured value of the G sensor 216.

A vehicle electric power supply 206 as a main electric power supply supplies the brake ECU 200 and the brake actuator 80 with required electric power. The vehicle electric power supply 206 includes, for example, a high-voltage battery and an auxiliary battery. Further, an auxiliary electric power supply 210 is provided independently of the vehicle electric power supply 206. Further, the auxiliary electric power supply 210 may be so connected as to be supplied with electric power from the vehicle electric power supply 206. The auxiliary electric power supply 210 is, for example, a capacitor provided as an attachment to the brake ECU 200. The vehicle electric power supply 206 and the auxiliary electric power supply 210 are connected to the brake ECU 200 via a monitoring circuit 208. The monitoring circuit 208 monitors the electric power supply voltage and other status quantities of the electric power supply and outputs them to the brake ECU 200.

A changeover circuit for making a changeover in electric power supply is also provided together with the monitoring circuit 208. The changeover circuit usually adopts an electric power supply for the brake ECU 200 and the brake actuator 80 as the vehicle electric power supply 206, and makes a changeover in electric power supply to the auxiliary electric power supply 210 when the voltage of the vehicle electric power supply 206 falls below a permissible range. The changeover circuit makes a changeover in electric power supply from the main electric power supply 206 to the auxiliary electric power supply 210, for example, during a transition to the backup mode. The monitoring circuit 208 and the changeover circuit may be provided as attachments to the auxiliary electric power supply 210.

The voltages of the vehicle electric power supply 206 and the auxiliary electric power supply 210 are periodically measured by the monitoring circuit 208. The low-voltage determination portion 204 is configured to receive an input of a measured electric power supply voltage value, and compares the measured voltage with a predetermined reference voltage to determine whether or not the electric power supply is in the low-voltage state. The control mode transition portion 202 refers to a comparison result or determination result in the low-voltage determination portion 204.

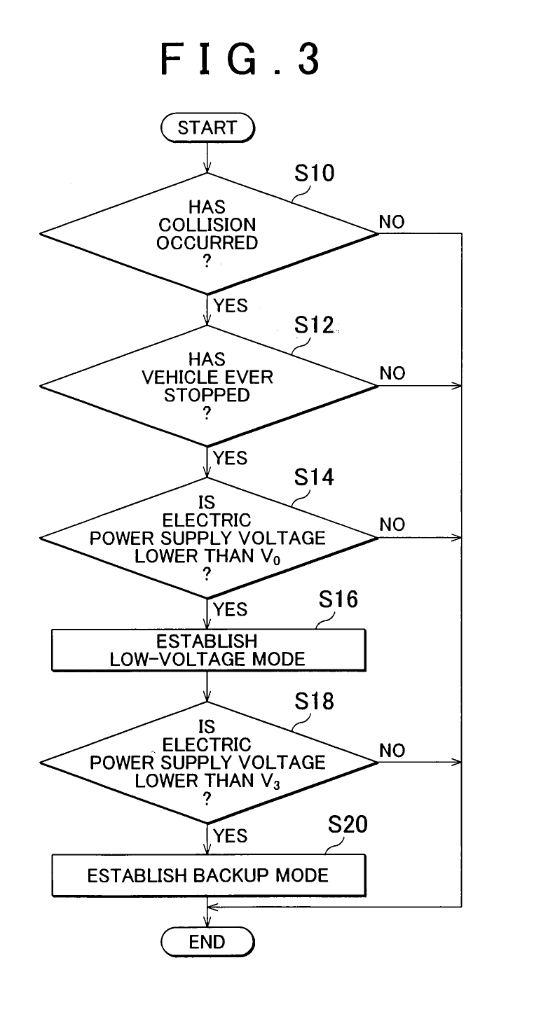

FIG. 3 is a flowchart for explaining an example of a brake control processing according to this embodiment of the invention. A brake control processing assuming a fall in the electric power supply voltage after a collision will be described herein as an example. The brake ECU 200 may periodically perform this processing. In parallel with this processing, the brake ECU 200 may control the wheel cylinder pressures and hence the braking force typically in the linear control mode in accordance with the braking operation of the driver. Further, the brake ECU 200 may also perform the aforementioned fluid pressure response abnormality determination processing in parallel with this processing.

In the processing shown in FIG. 3, the brake ECU 200 first determines whether or not there is a situation where a transition to the low-voltage mode should be made. At least when the electric power supply voltage is lower than a first reference value, the brake ECU 200 determines that a transition to the low-voltage mode should be made. When it is determined that a transition to the low-voltage mode should be made, the brake ECU 200 makes a transition to the low-voltage mode. For example, the brake ECU 200 makes a transition from the linear control mode to the low-voltage mode. When it is not determined that a transition to the low-voltage mode should be made, the brake ECU 200 continues the present brake mode. In the low-voltage mode, fluid pressure control is performed by the wheel cylinder pressure control portion according to the linear control mode. Further, in the low-voltage mode, the control current to a current supply target in the brake actuator 80 is adjusted such that the amount of electric power consumption becomes smaller than in the linear control mode. It should be noted that the brake ECU 200 may select the low-voltage mode when the occurrence of some abnormality in the electric power supply is detected, instead of selecting the low-voltage mode when the electric power supply voltage continues to fall.

Further, the brake ECU 200 determines whether or not the electric power supply voltage is lower than a second reference value in the low-voltage mode. The second reference value is set to, for example, a value smaller than the first reference value. When the electric power supply voltage is lower than the second reference value, the brake ECU 200 makes a changeover in brake mode from the low-voltage mode to the backup mode. When the electric power supply voltage is higher than the second reference value, the brake ECU 200 continues the low-voltage mode. It should be noted that the brake ECU 200 may restore the brake mode to the low-voltage mode when the electric power supply voltage recovers beyond the second reference value in the backup mode. Further, the brake ECU 200 may restore the brake mode to the linear control mode when the electric power supply voltage recovers beyond the first reference value in the low-voltage mode.

The processing shown in FIG. 3 will be described in more detail. The brake ECU 200 first determines whether or not the vehicle has undergone a collision (S10). The brake ECU 200 determines whether or not the vehicle has undergone a collision, depending on whether or not a vehicle body impact value has become larger than a criterial threshold G₁. The vehicle body impact value may be, for example, a maximum value of the deceleration generated in the vehicle. In this case, a measured value of the G sensor 216 is used as the vehicle body impact value. That is, the brake ECU 200 determines that the vehicle has undergone a collision when the acceleration measured by the G sensor 216 is larger than a predetermined value, and, determines that the vehicle has not undergone a collision when the acceleration measured by the G sensor 216 is equal to or smaller than the predetermined value. The criterial threshold G₁ is set to, for example, a value exceeding a range of the acceleration assumed to be generated in the vehicle during normal running. Considering that the occurrence of a collision is unlikely to be detected when the criterial threshold G₁ is set too large, the criterial threshold G₁ may be set in an appropriate manner, for example, experimentally or empirically. This criterial threshold may be set equal to, for example, an operation permission threshold of an airbag mounted on the vehicle. It should be noted that this determination on the occurrence of a collision can also be omitted.

When it is determined that the vehicle has undergone a collision (Y in S10), the brake ECU 200 determines whether or not there is a history indicating that the vehicle speed has become equal to zero after the collision (S12). That is, the brake ECU 200 determines whether or not the vehicle has ever stopped after the collision. When the result of this determination is positive, it is presumable that the vehicle can also run after stopping once following the collision. It should be noted that this determination on the stoppage of the vehicle can also be omitted.

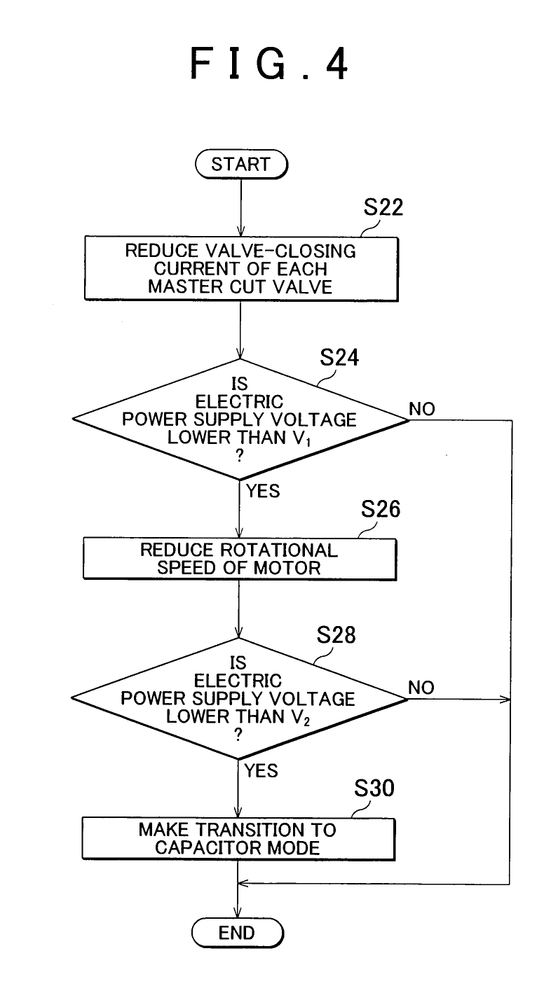

When it is determined that the vehicle has stopped after the collision (Y in S12), the brake ECU 200 determines whether or not the electric power supply voltage is lower than a low-voltage mode transition voltage V₀ (S14). The electric power supply voltage is, for example, the voltage of the main electric power supply 206 for the vehicle. When the electric power supply voltage is lower than the criterial threshold V₀ (Y in S14), the brake ECU 200 sets the brake mode to the low-voltage mode (S16). An example of the low-voltage mode will be described later with reference to FIG. 4. When the electric power supply voltage is equal to or higher than a criterial threshold V₀ (N in S14), the brake ECU 200 terminates this processing. By the same token, when the vehicle has not undergone a collision (N in S10) and also when the vehicle has not stopped after the collision (N in S12), the brake ECU 200 terminates this processing. In these cases, the present brake mode, for example, the linear control mode is simply continued.

In the low-voltage mode, the brake ECU 200 determines whether or not the electric power supply voltage is lower than a control stop voltage V₃ (S18). The control stop voltage V₃ is set to a value lower than the low-voltage mode transition voltage V₀. The control stop voltage V₃ is set to, for example, a minimum voltage guaranteeing the operation of the brake actuator 80. When the electric power supply voltage is lower than this criterial threshold V₃ (Y in S18), the brake ECU 200 sets the brake mode to the backup mode (S20). When the electric power supply voltage is equal to or higher than the criterial threshold V₃ (N in S18), the brake ECU 200 terminates this processing. In this case, the low-voltage mode is continued.

FIG. 4 is a flowchart for explaining an example of the low-voltage mode according to this embodiment of the invention. In the low-voltage mode according to this embodiment of the invention, the amount of electric power consumption is gradually reduced as the electric power supply voltage falls. Further, when the electric power supply voltage becomes lower than a predetermined threshold, a changeover in electric power supply is made from the main electric power supply 206 to the capacitor 210. The brake ECU 200 periodically repeats the processing shown in FIG. 4 in the low-voltage mode.

In the low-voltage mode, the brake ECU 200 first sets/changes the valve-closing current of each of the master cut valves 27 to a control current smaller than a prescribed value (S22). This reduced valve-closing current is set, for example, such that the valve-opening pressure of each of the master cut valves 27 coincides with a corresponding one of the wheel cylinder pressures that is equivalent to a predetermined ratio (e.g., 90%) of a maximum braking force assumed during running. The reduced valve-closing current may be set as a fixed value or varied. For example, the valve-closing current may be continuously or gradually reduced as the electric power supply voltage falls. It should be noted that a relationship between the valve-opening pressure of the control valve and the valve-closing current of the control valve is acquired for example, experimentally in advance and stored into the brake ECU 200.

In this manner, when the required braking force remains equal to or smaller than 90% of the maximum braking force, each of the master cut valves 27 is held closed. Therefore, each of the wheel cylinder pressures is given by the wheel cylinder pressure control portion. On the other hand, when the required braking force is larger than 90% of the maximum braking force, each of the master cut valves 27 is mechanically opened through a differential pressure. Thus, a required wheel cylinder pressure can be given. In this manner, while a braking force of a normal magnitude is applied by the wheel cylinder pressure control portion as in the case of the linear control mode, the master cylinder pressure can be supplementarily utilized to apply a braking force larger than usual.

Subsequently, the brake ECU 200 determines whether or not the electric power supply voltage is lower than a first criterial voltage V₁ (S24). The first criterial voltage V₁ is set, for example, to a value lower than the low-voltage mode transition voltage V₀ and larger than the control stop voltage V₃. When the electric power supply voltage is not lower than the first criterial voltage V₁ (N in S24), the brake ECU 200 terminates this processing. That is, a first electric power saving level corresponding to the reduction of the present valve-closing current of each of the master cut valves is continued.

On the other hand, when the electric power supply voltage is lower than the first criterial voltage V₁ (Y in S24), the brake ECU 200 sets/changes the rotational speed level of the motor 32 for driving the oil pump 34 from stationary rotation to a reduced state (S26). For example, the duty ratio of the current supplied to the motor 32 is reduced to a ratio smaller than usual. As a result, the motor 32 rotates slowly. Thus, more electric power can be saved. The rotational speed of the motor 32 may not necessarily be set to a fixed value but may be varied. For example, the rotational speed of the motor 32 may be continuously or gradually reduced as the electric power supply voltage falls.

Furthermore, the brake ECU 200 determines whether or not the electric power supply voltage is lower than a second criterial voltage V₂ (S28). The second criterial voltage V₂ is set to, for example, a value lower than the low-voltage mode transition voltage V₀ and higher than the control stop voltage V₃. In this embodiment of the invention, the second criterial voltage V₂ is lower than the first criterial voltage V₁. However, the second criterial voltage V₂ may be equal to the first criterial voltage V₁ or higher than the first criterial voltage V₁. When the electric power supply voltage is not lower than the second criterial voltage V₂ (N in S28), the brake ECU 200 terminates this processing. That is, a second electric power saving level corresponding to the reduction of the present valve-closing current of each of the master cut valves and the operation of the motor at low rotational speed is continued.

On the other hand, when the electric power supply voltage is lower than the second criterial voltage V₂ (Y in S28), the brake ECU 200 makes a transition to a capacitor mode (S30). That is, a changeover in electric power supply is made from the vehicle electric power supply 206 to the auxiliary electric power supply 210 is made. In the capacitor mode, only one or some of the four wheels (e.g., two of the wheels) may be controlled to save more electric power. In this case, the brake ECU 200 continues to control only one or some of the pressure increasing valves 40 and only one or some of the pressure reducing valves 42, and stops the other pressure increasing valves 40 or the other pressure increasing valve 40 and the other pressure reducing valves 42 or the other pressure reducing valve 42 from being controlled. Thus, a third electric power saving level corresponding to the reduction of the valve-closing current of each of the master cut valves, the operation of the motor at low rotational speed, and the reduction of the number of the valves to be controlled is provided. Thus, in the low-voltage mode, the amount of electric power consumption is gradually reduced as the electric power supply voltage falls from the first electric power saving level to the third electric power saving level.

For example, only the front wheels may be controlled in the capacitor mode. In this case, only the pressure increasing valves 40FR and 40FL on the front wheel side and the pressure reducing valves 42FR and 42FL on the front wheel side continue to be controlled. Alternatively, only the rear wheels may be controlled in the capacitor mode. In this mode, only the pressure increasing valves 40RR and 40RL on the rear wheel side and the pressure reducing valves 42RR and 42RL on the rear wheel side continue to be controlled. The front wheels are stopped from being controlled, and the master cut valves 27 are opened to introduce a master cylinder pressure. In the case where only the rear wheels are controlled, the wheel cylinder pressures in the rear wheels may be relatively low in general, and hence more electric power can be saved than in the case where only the front wheels are controlled. Further, the master pressure can be introduced to the front wheel side. Therefore, the braking of the four wheels can be continued.

In this embodiment of the invention, a changeover in electric power supply to the auxiliary electric power supply 210 is made in the backup mode (S20) shown in FIG. 3 as well. However, this mode is different from the capacitor mode (S30) shown in FIG. 4, because all the pressure increasing valves 40 and all the pressure reducing valves 42 are stopped from being controlled in the backup mode. Therefore, with a view to making a distinction between both the modes, the backup mode and the capacitor mode shown in FIG. 4 may be referred to as a first capacitor mode and a second capacitor mode respectively for the sake of convenience. That is, in the second capacitor mode, wheel cylinder pressure control by one or some of the pressure increasing valves 40 and one or some of the pressure reducing valves 42 is continued. When the voltage further falls to reach the control stop voltage V₃, a transition to the first capacitor mode is made to stop all the pressure increasing valves 40 and all the pressure reducing valves 42 from being controlled.

The details of the electric power saving levels are not limited as described above. Other suitable combinations and changes in sequence are possible. As an example, the first electric power saving level may correspond to the operation of the motor at low rotational speed, and the second electric power saving level may correspond to the reduction of the valve-closing currents of the master cut valves and the operation of the motor at low rotational speed. For example, the operation of the motor at low rotational speed may be preceded by the reduction of the valve-closing currents of the master cut valves 27 when the reduction of the valve-closing currents is more effective for electric power saving, and the reduction of the valve-closing currents of the master cut valves 27 may be preceded by the operation of the motor at low rotational speed when the operation of the motor at low rotational speed is effective for electric power saving. Further, the highest electric power saving level may be set right after a transition to the low-voltage mode, instead of gradually raising the electric power saving level. Further, electric power may be saved only through the reduction of the valve-closing currents in the low-voltage mode, only through the operation of the motor in the low-voltage mode, or only in the capacitor mode.

While the various elements of the example embodiment are shown in various combinations and configurations, other combinations and configurations, including more, less or only a single element, are also within the scope of the invention.

1-3. (canceled)

4. A control method for a brake that includes
an electric power supply,
a fluid pressure source whose operating fluid pressure fluctuates in response to an operation of a driver,
a wheel cylinder that is supplied with an operating fluid from the fluid pressure source to apply a braking force to a wheel, and
a control valve that is provided between the fluid pressure source and the wheel cylinder and can be mechanically opened through an effect of a differential pressure at a time when a higher pressure is applied to the fluid pressure source side than to the wheel cylinder side, the control valve being a normally open valve that is closed through a prescribed control current that is so set as not to mechanically open the control valve through the effect of the differential pressure during normal braking, the control method comprising:
determining whether or not the electric power supply is in a low-voltage state; and
closing the control valve through a control current smaller than the prescribed control current when it is determined that the electric power supply is in the low-voltage state.

5. A brake control apparatus comprising:
an electric power supply;
a fluid pressure source whose operating fluid pressure fluctuates in response to an operation of a driver;
a wheel cylinder that is supplied with an operating fluid from the fluid pressure source to apply a braking force to a wheel;
a control valve that is provided between the fluid pressure source and the wheel cylinder and can be mechanically opened through an effect of a differential pressure at a time when a higher pressure is applied to the fluid pressure source side than to the wheel cylinder side, the control valve being a normally open valve that is closed through a prescribed control current that is so set as not to mechanically open the control valve through the effect of the differential pressure during normal braking; and
a control portion that controls opening/closing of the control valve through a control current, the control portion determining whether or not the electric power supply is in a low-voltage state and closing the control valve through a control current smaller than the prescribed control current upon determining that the electric power supply is in the low-voltage state.

6. The brake control apparatus according to claim 5, further comprising a wheel cylinder pressure control portion capable of controlling a wheel cylinder pressure independently of a brake operation of the driver,
wherein the control portion sets an upper limit for the wheel cylinder pressure rendered by the wheel cylinder pressure control portion in the low-voltage state, and controls a control current in the low-voltage state such that the control valve is mechanically opened when a required wheel cylinder pressure is higher than the upper limit.

7. The brake control apparatus according to claim 5, further comprising a motive power source for pressurizing and storing an operating fluid,
wherein the control portion operates the motive power source at a lower speed than usual in the low-voltage state.
